(19) United States
(12) Patent Application Publication
(10) Pub. No.: US 2013/0260689 A1
(43) Pub. Date: Oct. 3, 2013

(54) Wirelessly Powered Input Device

(71) Applicants: Anssi K. Haverinen, San Diego, CA (US); Dean M. Saldanha, San Diego, CA (US)

(72) Inventors: Anssi K. Haverinen, San Diego, CA (US); Dean M. Saldanha, San Diego, CA (US)

(73) Assignee: QUALCOMM INCORPORATED, San Diego, CA (US)

(21) Appl. No.: 13/436,721

(22) Filed: Mar. 30, 2012

(51) Int. Cl. H04B 7/26

(52) U.S. Cl. 455/41.2

(57) ABSTRACT

A method, an apparatus, and a computer program product for powering a battery-less wireless input device are provided in which the battery-less wireless input device is coupled with a short-range communications target. The short-range communications target includes an energy harvester for harvesting energy generated by a short-range communications initiator when the short-range communications initiator communicates with the short-range communications target. The battery-less wireless input device receives the harvested energy for powering itself from the energy harvester when the short-range communications initiator communicates with the short-range communications target. The battery-less wireless input device may include a capacitor for storing the received harvested energy. Accordingly, the input device may electrically operate without being powered by a battery, and may therefore have a reduced size and weight.

### BACKGROUND

1. Field

The present disclosure relates generally to wireless input devices, and more particularly, to powering battery-less wireless input devices.

2. Background

Wireless input devices such as Bluetooth keypads, mice, and touch pads require a power source to operate. The required power source may be a battery, for example. However, the power source adds physical size and/or weight to the input devices. This may be counterproductive to input devices that are designed to be small or thin. For example, for an input medium such as touch-sensitive paper, utility lies at least in part in its extremely thin stature or lack of weight. Therefore, using a battery to power the touch-sensitive paper would defeat any utility with respect to size and/or weight. Accordingly, it would be beneficial to be able to power wireless input devices without having to use a bulky battery or similar power source.

### SUMMARY

In an aspect of the disclosure, a method, an apparatus, and a computer program product for powering a battery-less wireless input device are provided in which the battery-less wireless input device is coupled with a short-range communications target. The short-range communications target includes an energy harvester for harvesting energy generated by a short-range communications initiator when the short-range communications initiator communicates with the short-range communications target. The battery-less wireless input device receives the energy from the energy harvester to power itself when the short-range communications initiator communicates with the short-range communications target. Accordingly, the input device may electrically operate without being powered by a battery, and may therefore have a reduced size and weight.

### BRIEF DESCRIPTION OF THE DRAWINGS

FIG. 1 is a diagram illustrating a system for powering a wireless device.

FIG. 2 is a flow chart of a method of powering a battery-less wireless input device.

FIG. 3 is a conceptual data flow diagram illustrating the data flow between different modules/means/components in an exemplary apparatus.

FIG. 4 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects for powering devices will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In the technological field of short range wireless connectivity, a user may conduct secure two-way transactions between electronic devices. Examples of such technologies include near field communications (NFC), Bluetooth, and radio frequency identification (RFID). Using these technologies, a user may perform contactless transactions, access digital content, and connect electronic devices by bringing the devices close together.

NFC is a short-range high frequency wireless communication technology which enables the exchange of data between devices that are within a 10 cm distance, approximately. In NFC, a communication initiator and a communication target are typically involved, wherein the communication initiator may actively generate an NFC field to read and/or write onto the communication target. The communication initiator may be a polling device, such as an NFC Forum Reader/Writer or an ISO/IEC-14443 PCD, for example. The communication target may be a listening device, such as an NFC Forum Card Emulator or an ISO/IEC-14443 PICC, for example.

The NFC field can power a passive communication target. This enables communication targets to have very simple form factors such as tags, stickers, key fobs, or cards that do not require batteries. NFC tags, for example, may contain data that may be read and/or rewritten by the communication initiator upon generating the NFC field. The communication targets can securely store personal data such as debit and credit card information, loyalty program data, personal identification numbers (PINs), networking contacts, and other information.

Three uses for NFC include: 1) card emulation; 2) reader mode; and 3) peer-to-peer (P2P) mode. In card emulation, the communication target may behave like a contactless card to be read by the communication initiator in conjunction with payments, ticketing, transport, access control, etc. In reader mode, the communication initiator is active and may read a passive communication target, such as an interactive advertisement, for example. In P2P mode, two NFC devices may communicate with each other to exchange information.

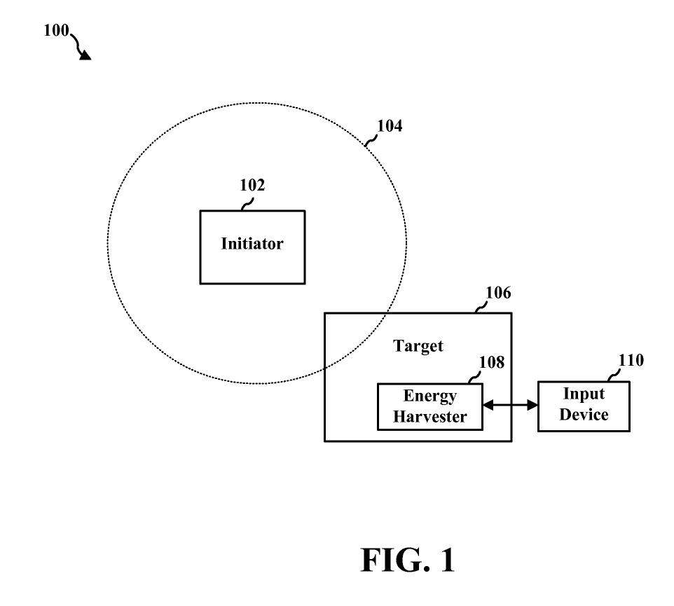

FIG. 1 is a diagram illustrating a system 100 for powering a wireless device. Although the system 100 may be described with respect to NFC, it is contemplated that other short-range wireless technologies, including but not limited to, Bluetooth and RFID, may be applicable. Furthermore, alternative radio technologies, including but not limited to, Wi-Fi and IEEE 802.11 may be used for a longer operating distance, higher bandwidth, or higher power supply capability.

The system 100 includes a short-range communications initiator 102, such as a polling device, an NFC Forum Reader/Writer, or an ISO/IEC-14443 PCD, and a short-range communications target 106, such as a listening device, an NFC Forum Card Emulator, or an ISO/IEC-14443 PICC. When the communications target 106 is within a communication range 104 (e.g. approximately 10 cm or less) of the communications initiator 102, the communications initiator 102 may generate an NFC field to communicate with the communications target 106 in order to read and/or write onto the communications target 106. Consequently, the NFC field generated by the communications initiator 102 may induce power to the communications target 106.

The communications target 106 may include an energy harvester 108, such as an NFC integrated circuit or NFC chip. When the communications target 106 is within the communication range 104, and the communications initiator 102 generates the NFC field to communicate with the communications target 106, the energy harvester 108 may receive wireless energy from the field generated by the communications initiator 102 and convert the energy into current for powering external circuits. For example, an NFC integrated circuit/chip may output as much as 9 mW of harvested energy for powering external circuits, such as a secure element which may act as a passive memory.

A very low power input device 110 may be electrically coupled to the energy harvester 108, in addition to, or instead of, the passive memory. As shown in FIG. 1, the input device 110 is separate from the communications target 106. However, the input device 110 may be integrated with the communications target 106 to form a single device. Accordingly, the input device 110 may be powered via the energy harvester 108 by the NFC field generated by the communications initiator 102 when communicating with the communications target 106. The input device 110 may include a capacitor or other electrical component for storing the received harvested energy. Accordingly, the input device 110 may electrically operate without being powered by a battery, and may therefore have a reduced size and weight.

The input device 110 may be a man-machine interface. Examples of the input device 110 include, but are not limited to, touch-sensitive paper, touch panels, keypads, and mice. In an aspect, the communications initiator 102 may poll (sample) the state of the input device 110 periodically to detect input events such as key presses or a touch panel state. Examples in which the system 100 may be implemented include, but are not limited to, smart posters where touching the poster changes data presented to the communications initiator, touch screens with a display, and electronic notepads where a pen input is captured digitally.

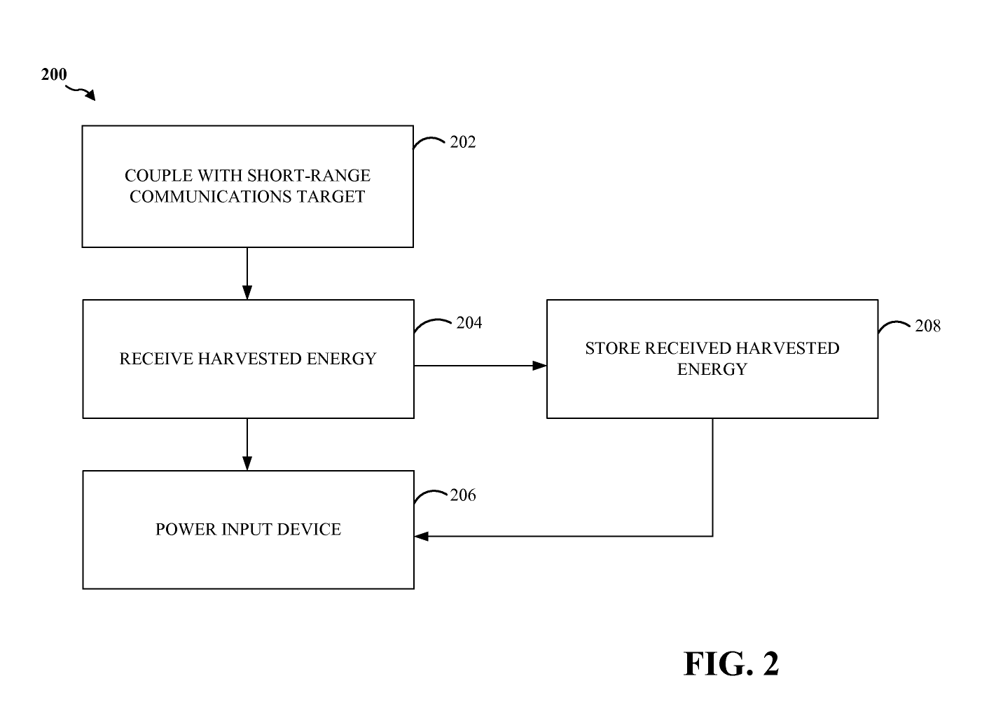

FIG. 2 is a flow chart 200 of a method of powering a battery-less wireless input device. The method may be performed by a battery-less wireless input device, such as touch-sensitive paper, a touch panel, a keypad, a mouse, or other man-machine interface. At step 202, the input device couples with a short-range communications target. The short-range communications target may be a listening device, an NFC Forum Card Emulator, or an ISO/IEC-14443 PICC. Alternatively, the short-range communications target may be a communications target of an alternative radio technology, such as Bluetooth, RFID, Wi-Fi, and IEEE 802.11, for example. The short-range communications target includes an energy harvester for harvesting energy generated by a short-range communications initiator when the short-range communications initiator communicates with the short-range communications target. The short-range communications initiator may be a polling device, and NFC Forum Reader/Writer, or an ISO/IEC-14443 PCD. Alternatively, the short-range communications initiator may be a communications initiator of an alternative radio technology, such as Bluetooth, RFID, Wi-Fi, and IEEE 802.11, for example.

At step 204, the input device receives the harvested energy from the energy harvester of the short-range communications target when the short-range communications initiator communicates with the short-range communications target. The input device may power itself with the received harvested energy.

At step 206, the input device may directly power itself with the received harvested energy. Alternatively, at step 208, the input device may first store the received harvested energy in a capacitor or other electrical component, and thereafter, proceed to step 206 to power itself with the harvested energy stored in the capacitor. Accordingly, the input device may be powered without a battery, and may therefore have a reduced size and weight.

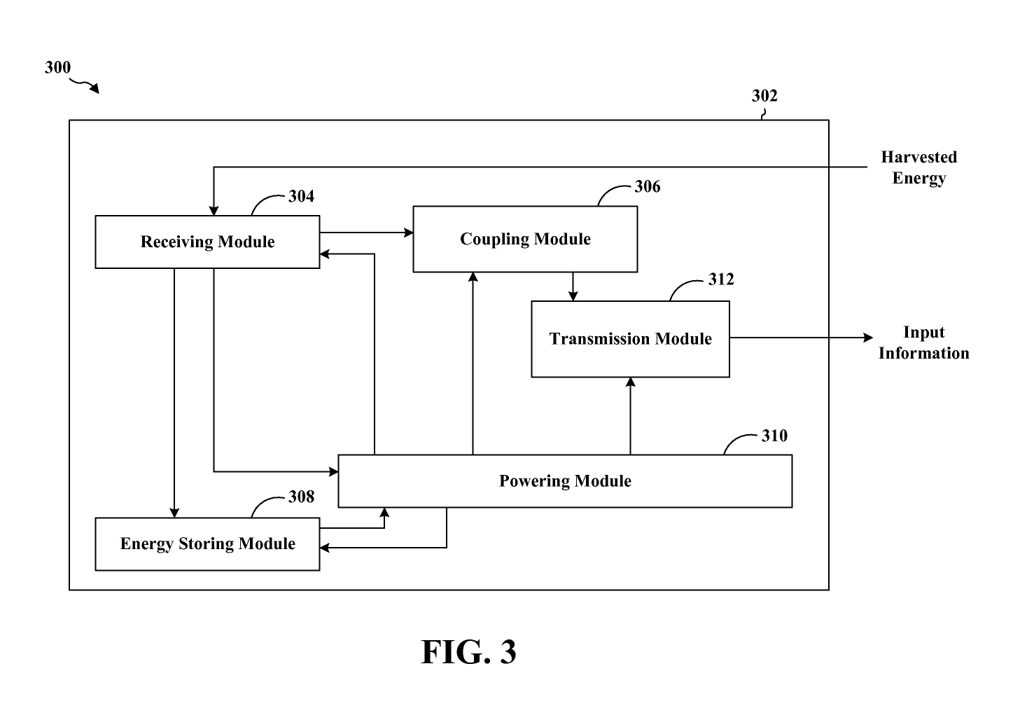

FIG. 3 is a conceptual data flow diagram 300 illustrating the data flow between different modules/means/components in an exemplary apparatus 302. The apparatus may be a battery-less wireless input device, such as touch-sensitive paper, a touch panel, a keypad, a mouse, or other man-machine interface. The apparatus 302 includes a receiving module 304, a coupling module 306, an energy storing module 308, a powering module 310, and a transmission module 312.

The coupling module 306 couples with a short-range communications target. The short-range communications target may be a listening device, an NFC Forum Card Emulator, or an ISO/IEC-14443 PICC. Alternatively, the short-range communications target may be a communications target of an alternative radio technology, such as Bluetooth, RFID, Wi-Fi, and IEEE 802.11, for example. The short-range communications target includes an energy harvester for harvesting energy generated by a short-range communications initiator when the short-range communications initiator communicates with the short-range communications target. The short-range communications initiator may be a polling device, and NFC Forum Reader/Writer, or an ISO/IEC-14443 PCD. Alternatively, the short-range communications initiator may be a communications initiator of an alternative radio technology, such as Bluetooth, RFID, Wi-Fi, and IEEE 802.11, for example.

The receiving module 304 receives the harvested energy from the energy harvester of the short-range communications target when the short-range communications initiator communicates with the short-range communications target. Accordingly, the received harvested energy may be used by the powering module 310 to power other modules of the apparatus 302, such as the receiving module 304, the coupling module 306, the energy storing module 308, or the transmission module 312.

The powering module 310 may directly power the other modules of the apparatus 302 with the harvested energy received from the receiving module 304. Alternatively, the received harvested energy may first be stored in the energy storing module 308. The powering module may then power the other modules of the apparatus 302 with the harvested energy stored in the energy storing module 308. The energy storing module 308 may be a capacitor or other electrical component used for storing energy. The transmission module 312 may provide information regarding a state of the apparatus 302, such as key presses, a touch panel state, or other input events. Accordingly, the apparatus 302 may electrically operate without being powered by a battery, and may therefore have a reduced size and weight.

The apparatus may include additional modules that perform each of the steps of the algorithm in the aforementioned flow chart FIG. 2. As such, each step in the aforementioned flow chart FIG. 2 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

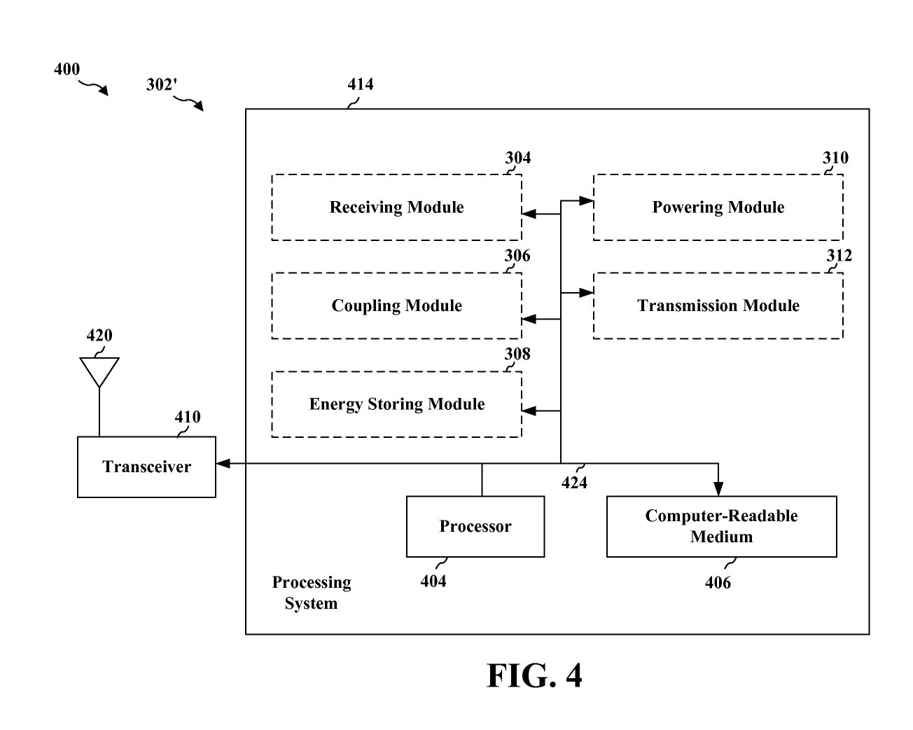

FIG. 4 is a diagram illustrating an example of a hardware implementation for an apparatus 302′ employing a processing system 414. The processing system 414 may be implemented with a bus architecture, represented generally by the bus 424. The bus 424 may include any number of interconnecting buses and bridges depending on the specific application of the processing system 414 and the overall design constraints. The bus 424 links together various circuits including one or more processors and/or hardware modules, represented by the processor 404, the modules 304, 306, 308, 310, 312 and the computer-readable medium 406. The bus 424 may also link various other circuits such as timing sources, peripherals, voltage regulators, and power management circuits, which are well known in the art, and therefore, will not be described any further.

The processing system 414 may be coupled to a transceiver 410. The transceiver 410 is coupled to one or more antennas 420. The transceiver 410 provides a means for communicating with various other apparatus over a transmission medium. The processing system 414 includes a processor 404 coupled to a computer-readable medium 406. The processor 404 is responsible for general processing, including the execution of software stored on the computer-readable medium 406. The software, when executed by the processor 404, causes the processing system 414 to perform the various functions described supra for any particular apparatus. The computer-readable medium 406 may also be used for storing data that is manipulated by the processor 404 when executing software. The processing system further includes at least one of the modules 304, 306, 308, 310 and 312. The modules may be software modules running in the processor 404, resident/stored in the computer readable medium 406, one or more hardware modules coupled to the processor 404, or some combination thereof.

In one configuration, the apparatus 302/302′ for powering a battery-less wireless input device includes means for coupling with a short-range communications target, the short-range communications target including an energy harvester for harvesting energy generated by a short-range communications initiator when the short-range communications initiator communicates with the short-range communications target, means for receiving the harvested energy for powering the battery-less wireless input device from the energy harvester when the short-range communications initiator communicates with the short-range communications target, means for powering the battery-less wireless input device with the received harvested energy, means for storing the received harvested energy in a capacitor, and means for powering the battery-less wireless input device with the harvested energy stored in the capacitor. The aforementioned means may be one or more of the aforementioned modules of the apparatus 302 and/or the processing system 414 of the apparatus 302′ configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for powering a battery-less wireless input device, comprising:
coupling with a short-range communications target, the short-range communications target including an energy harvester for harvesting energy generated by a short-range communications initiator when the short-range communications initiator communicates with the short-range communications target; and
receiving the harvested energy for powering the battery-less wireless input device from the energy harvester when the short-range communications initiator communicates with the short-range communications target.

2. The method of claim 1, further comprising powering the battery-less wireless input device with the received harvested energy.

3. The method of claim 1, further comprising storing the received harvested energy in a capacitor.

4. The method of claim 3, further comprising powering the battery-less wireless input device with the harvested energy stored in the capacitor.

5. The method of claim 1, wherein the short-range communications target is one of a listening device, a near field communications (NFC) Forum Card Emulator, or an ISO/IEC-14443 PICC, and the short-range communications initiator is one of a polling device, an NFC Forum Reader/Writer, or an ISO/IEC-14443 PCD.

6. A battery-less wireless input device, comprising:
means for coupling with a short-range communications target, the short-range communications target including an energy harvester for harvesting energy generated by a short-range communications initiator when the short-range communications initiator communicates with the short-range communications target; and
means for receiving the harvested energy for powering the battery-less wireless input device from the energy harvester when the short-range communications initiator communicates with the short-range communications target.

7. The battery-less wireless input device of claim 6, further comprising means for powering the battery-less wireless input device with the received harvested energy.

8. The battery-less wireless input device of claim 6, further comprising means for storing the received harvested energy in a capacitor.

9. The battery-less wireless input device of claim 8, further comprising means for powering the battery-less wireless input device with the harvested energy stored in the capacitor.

10. The battery-less wireless input device of claim 6, wherein the short-range communications target is one of a listening device, a near field communications (NFC) Forum Card Emulator, or an ISO/IEC-14443 PICC, and the short-range communications initiator is one of a polling device, an NFC Forum Reader/Writer, or an ISO/IEC-14443 PCD.

11. A battery-less wireless input device, comprising:
a processing system configured to:
couple with a short-range communications target, the short-range communications target including an energy harvester for harvesting energy generated by a short-range communications initiator when the short-range communications initiator communicates with the short-range communications target; and
receive the harvested energy for powering the battery-less wireless input device from the energy harvester when the short-range communications initiator communicates with the short-range communications target.

12. The battery-less wireless input device of claim 11, wherein the processing system is further configured to power the battery-less wireless input device with the received harvested energy.

13. The battery-less wireless input device of claim 11, wherein the processing system is further configured to store the received harvested energy in a capacitor.

14. The battery-less wireless input device of claim 13, wherein the processing system is further configured to power the battery-less wireless input device with the harvested energy stored in the capacitor.

15. The battery-less wireless input device of claim 11, wherein the short-range communications target is one of a listening device, a near field communications (NFC) Forum Card Emulator, or an ISO/IEC-14443 PICC, and the short-range communications initiator is one of a polling device, an NFC Forum Reader/Writer, or an ISO/IEC-14443 PCD.

16. A computer program product, comprising:
a computer-readable medium comprising code for:
coupling a battery-less wireless input device with a short-range communications target, the short-range communications target including an energy harvester for harvesting energy generated by a short-range communications initiator when the short-range communications initiator communicates with the short-range communications target; and
receiving in the battery-less wireless input device the harvested energy for powering the battery-less wireless input device from the energy harvester when the short-range communications initiator communicates with the short-range communications target.

17. The computer program product of claim 16, wherein the computer-readable medium further comprises code for powering the battery-less wireless input device with the received harvested energy.

18. The computer program product of claim 16, wherein the computer-readable medium further comprises code for storing the received harvested energy in a capacitor.

19. The computer program product of claim 18, wherein the computer-readable medium further comprises code for powering the battery-less wireless input device with the harvested energy stored in the capacitor.

20. The computer program product of claim 16, wherein the short-range communications target is one of a listening device, a near field communications (NFC) Forum Card Emulator, or an ISO/IEC-14443 PICC, and the short-range communications initiator is one of a polling device, an NFC Forum Reader/Writer, or an ISO/IEC-14443 PCD.

21. A system for powering a battery-less wireless input device, comprising:
a battery-less wireless input device;
a short-range communications target coupled to the wireless input device, the short-range communications target including an energy harvester for harvesting energy; and
a short-range communications initiator for generating energy harvested by the energy harvester when the short-range communications initiator communicates with the short-range communications target,
wherein the energy harvester powers the wireless input device with the harvested energy when the short-range communications initiator communicates with the short-range communications target.

22. The system of claim 21, wherein the battery-less wireless input device comprises a capacitor for storing the harvested energy.

23. The system of claim 21, wherein the short-range communications target is one of a listening device, a near field communications (NFC) Forum Card Emulator, or an ISO/IEC-14443 PICC, and the short-range communications initiator is one of a polling device, an NFC Forum Reader/Writer, or an ISO/IEC-14443 PCD.
